(19) United States
(12) Patent Application Publication
(10) Pub. No.: US 2009/0044672 A1
(43) Pub. Date: Feb. 19, 2009

(54) Apparatus for Forming Tin Flakes

(75) Inventor: Jinzhong Li, Xi An City (CN)

Correspondence Address: GROSSMAN, TUCKER, PERREAULT & PFLEGER, PLLC, 55 SOUTH COMMERICAL STREET, MANCHESTER, NH, 03101, US

(73) Assignees: DELTA ELECTRONICS POWER (DONGGUAN) CO., LTD., Dong-Guan City (CN); DELTA ELECTRONICS, INC., Taoyuan Hsien (TW)

(21) Appl. No.: 12/110,458

(22) Filed: Apr. 28, 2008

(30) Foreign Application Priority Data
Aug. 16, 2007 (CN) 200710029749.9

(51) Int. Cl. B26D 5/22; B21B 1/16

(52) U.S. Cl. 83/229; 72/203; 72/250

(57) ABSTRACT

An apparatus for forming tin flakes from a continuous tin wire is provided. The apparatus for forming tin flakes comprises a driving apparatus, a feeding mechanism, a cutting mechanism, a linkage mechanism and a fixed cutter. The feeding mechanism comprises a conveying mechanism and a forming mechanism. The conveying mechanism transports the continuous tin wire to the forming mechanism along the first direction. The forming mechanism rolls a portion of the tin wire into a fine strip along the first direction. The cutting mechanism is driven to move from the first position to the second position, in which the driving apparatus cuts off a portion of the tin strip to form tin flakes. The linkage mechanism drives the forming mechanism to feed a predetermined length of the tin strip along the first direction. The fixed cutter is adapted to cut off a portion of the tin strip when the cutting mechanism is disposed along the second position.

This application claims priority to Chinese Patent Application No. 200710029749.9 filed on Aug. 16, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a tin flake forming apparatus that is adapted to form tin flakes from a continuously wound tin wire for repairing soldered electronic components.

2. Descriptions of the Related Art

With the continuous advancement of science and technologies, various modern electronic products are becoming more widespread and diversified. Moreover, electronic products are increasingly miniaturized and light weight to cater for consumers' needs. Therefore, improved technologies for assembling electronic components must be provided accordingly. Among a new generation of such assembling technologies, surface mounting technology (SMT) has gradually replaced conventional wave soldering processes that require manually plugging operations. Because surface mounting technology has reduced the volume of conventional electronic components remarkably, electronic products can still be assembled with a high density, a high reliability, at low costs and in miniaturized forms through an automatic production process.

Most of the current electronic products, especially computers and electronic communication products, have adopted surface mounting technology. However, because different electronic components have different requirements on the soldering tin amount, the conventional solution featuring a consistent tin paste printing thickness have failed to meet the requirements of the electronic components with different specifications. A poor soldering quality is often found due to an insufficient soldering tin. To remedy such defects, manual repair soldering must be implemented, which inevitably adds to labor costs and decreases the production efficiency. Moreover, it is difficult to guarantee the quality of the products.

The conventional surface mounting technology often requires manual repair soldering, which not only wastes human labor and time, but makes it difficult to guarantee the quality of the products. Accordingly, it is highly desirable in the art to provide a technology for automatic repair soldering, as well as an apparatus and a repair soldering material.

### SUMMARY OF THE INVENTION

One objective of this invention is to overcome the shortcoming of the prior art technologies by making a repair soldering process more automatic. Accordingly, this invention provides a tin flake forming apparatus for forming tin flakes adapted to repair soldering electronic components of various specifications from a continuously wound tin wire.

This invention provides an apparatus for forming a continuous tin wire into at least one tin flake. The tin flake forming apparatus comprises a driving device, a feeding mechanism, a cutting mechanism, a linkage mechanism and a fixed cutter. The feeding mechanism comprises a conveying mechanism and a forming mechanism. The conveying mechanism transports the continuous tin wire to the forming mechanism along a first direction, while the forming mechanism rolls a portion of the tin wire into a tin strip along the first direction. The cutting mechanism, which is driven by the driving device, moves from a first position to a second position to cut off a portion of the rolled tin strip to form the one tin flake, and then moves back from the second position to the first position after cutting off the rolled tin strip. The linkage mechanism is linked between the cutting mechanism and the forming mechanism. When the cutting mechanism moves back from the second position to the first position, the forming mechanism is driven to feed a predetermined length of the tin strip along the first direction. The fixed cutter is disposed on a lateral side of the forming mechanism. The cutting mechanism has a moving cutter. When the cutting mechanism is disposed along the second position, an inner edge of the moving cutter is longitudinally aligned with an outer edge of the fixed cutter to cut off a portion of the tin strip.

The tin flake forming apparatus of this invention feeds the tin wire, and uses a driving device to carry out the forming and cutting operations, thus providing a simplified overall structure and highly automated operation of the apparatus. By using tin flakes formed by the tin flake forming apparatus of this invention, an automated repair soldering procedure can be implemented to reduce labor and costs.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective view of the tin flake forming apparatus in the preferred embodiment of this invention;

FIG. 2 is a perspective view of the stock device and a part of the feeding mechanism in the preferred embodiment of this invention;

FIG. 3 is a perspective view of the forming mechanism, a portion of the linkage mechanism and a portion of a stop device in the preferred embodiment of this invention;

FIG. 4A is a perspective view of an eccentric crank mechanism of the cutting mechanism in the preferred embodiment of this invention;

FIG. 4B is a perspective exploded view of the cutting mechanism and the fixed cutter in the preferred embodiment of this invention;

FIG. 4C is an exploded side view of the cutting mechanism, the fixed cutter and a part of the tin strip positioning device in the preferred embodiment of this invention; and

FIG. 5 is a side view of a part of the cutting mechanism, a part of the linkage mechanism and a part of the stop device in the preferred embodiment of this invention.

### DESCRIPTION OF THE PREFERRED EMBODIMENT

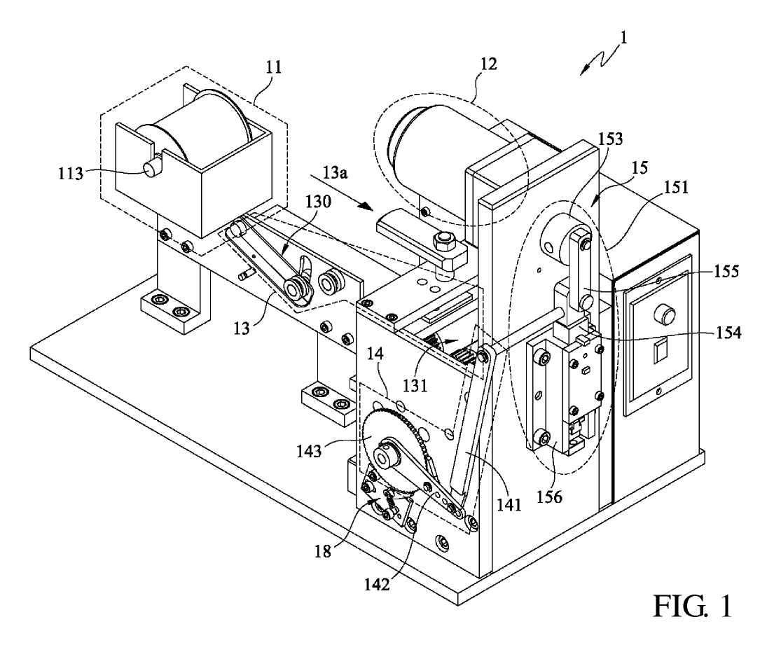

FIG. 1 illustrates the preferred embodiment of this invention, which is a tin flake forming apparatus 1 for forming a plurality of tin flakes from a continuous tin wire. The tin flake forming apparatus 1 comprises a stock device 11, a driving device 12, a feeding mechanism 13, a linkage mechanism 14, a cutting mechanism 15, a fixed cutter 16, a tin strip positioning device and a stop device 18.

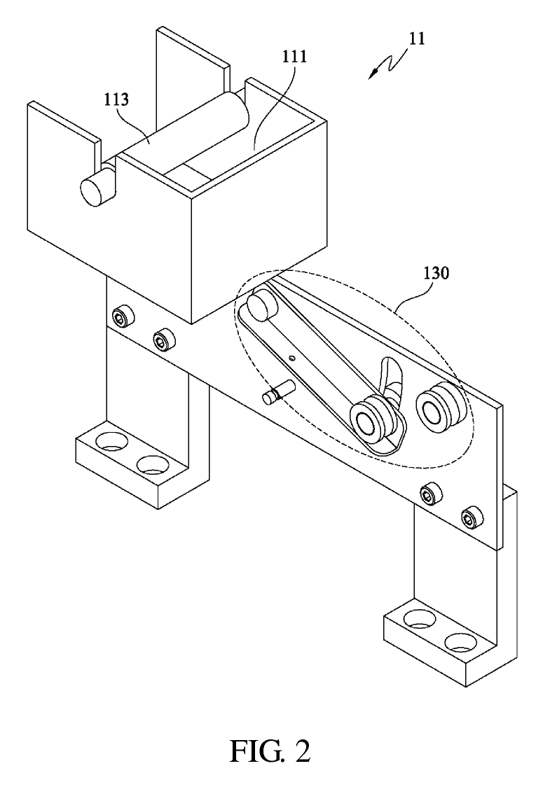

Referring to FIG. 1 and FIG. 2 together, FIG. 2 is a perspective view of the stock device 11 and a part of the feeding mechanism 13. The stock device 11 includes a stock tank 111 and a rotating shaft 113. A continuous tin wire wound around the rotating shaft 113 is loaded in the stock tank 111 and is dispensed to a conveying mechanism 130 of the feeding mechanism 13. The feeding mechanism 13 comprises the conveying mechanism 130 and a forming mechanism 131. The conveying mechanism 130 is adapted to convey the continuous wound tin wire loaded in the stock device 11 to the forming mechanism 131 along the first direction 13a.

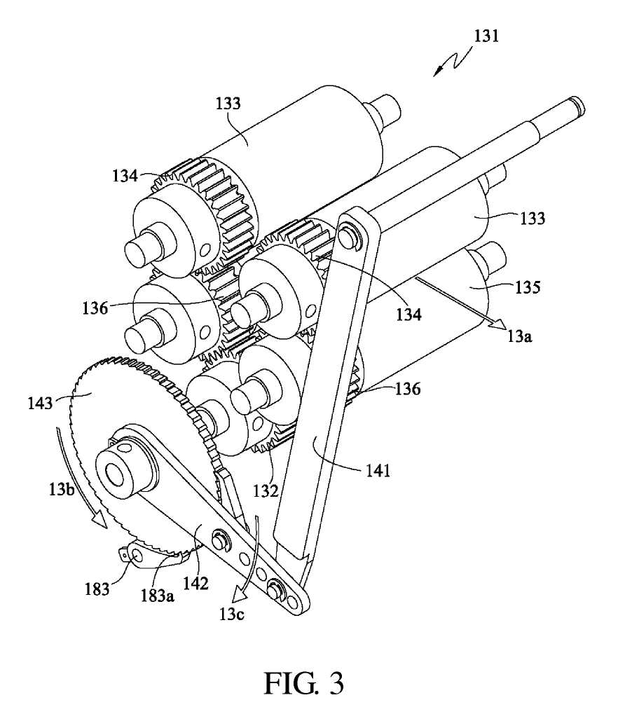

Referring to FIG. 1 and FIG. 3 together, FIG. 3 is a perspective view of the forming mechanism 131, a part of the linkage mechanism 14 and a part of the stop device 18. The forming mechanism 131 comprises two pairs of rolling gears and a driving gear 132. Each pair of rolling gears comprises an upper roller 133, an upper gear 134, a lower roller 135 and a lower gear 136. The upper gear 134 and the lower gear 136 mesh with the driving gear 132 respectively, while the upper roller 133 and the lower roller 135 are driven by the upper gear 134 and the lower gear 136 respectively. When a ratchet wheel 143 of the linkage mechanism 14 rotates around a center in a first rotating direction 13b, the driving gear 132 drives the lower gear 136 of the rolling gear and indirectly drives the two pairs of rolling gears, so that a portion of the continuous tin wire conveyed from the conveying mechanism 130 to the forming mechanism 131 passes between the two pairs of rolling gears, where the tin wire is rolled into a tin strip and fed a predetermined length forward along the first direction 13a. In this embodiment, when viewed in FIG. 3, the first rotating direction 13b is counter-clockwise. In other words, the ratchet wheel 143, the driving gear 132 and the upper gear 134 all rotate in a counter-clockwise direction, while the lower gear 136 rotates in a second rotating direction 13c, which is in the clockwise direction.

In this embodiment, the driving device 12 may be an electric motor. An output power of the electric motor is transmitted to a driving wheel 153 of an eccentric crank mechanism 151 of the cutting mechanism 15 via a motor spindle that serves as the power output end.

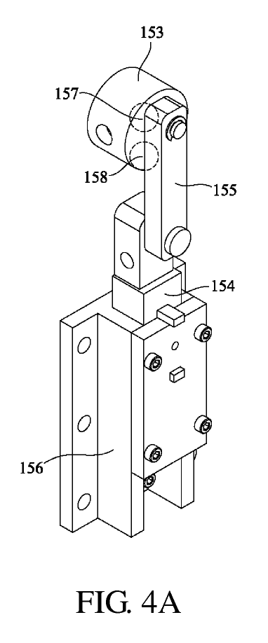

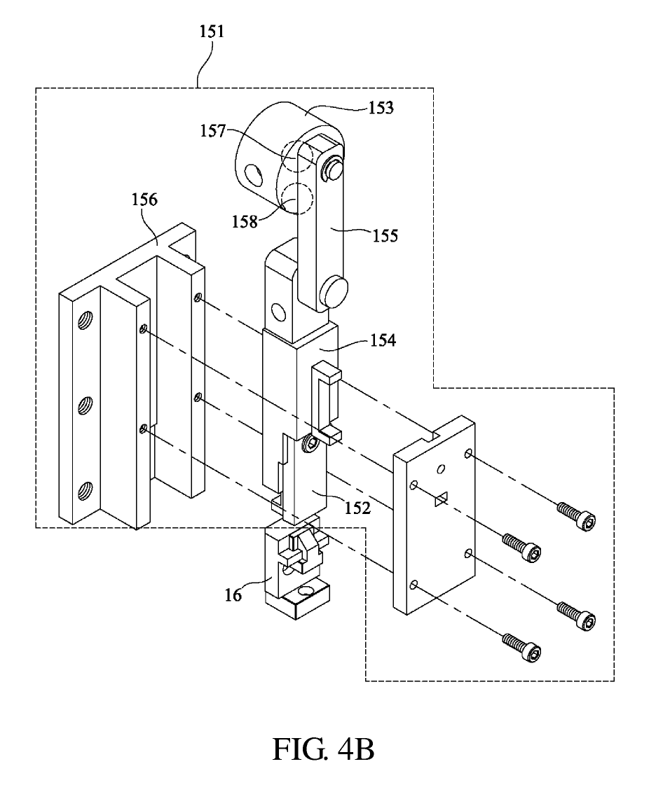

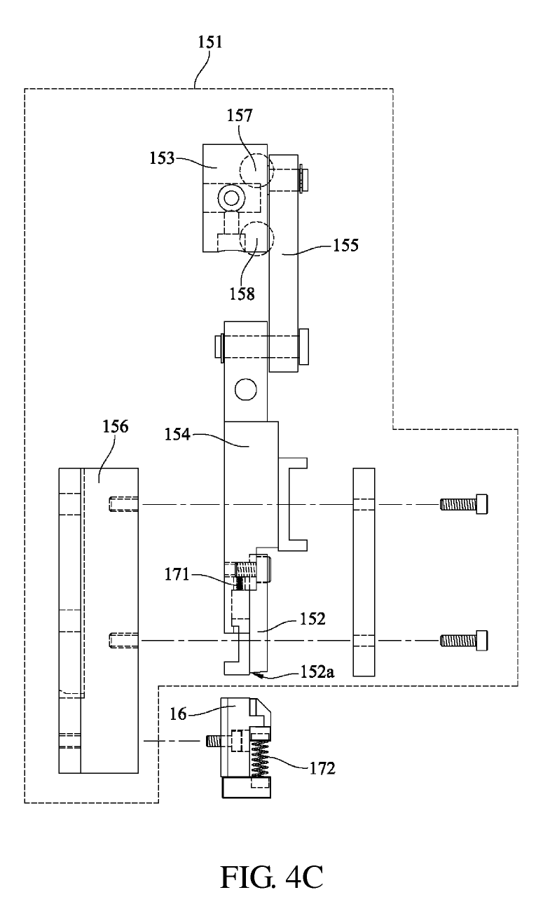

Referring to FIG. 1, FIG. 4A, FIG. 4B and FIG. 4C together, FIGS. 4A to 4C are perspective view of the eccentric crank mechanism 151 of the cutting mechanism 15, a perspective exploded view and an exploded side view of the cutting mechanism 15 and the fixed cutter 16 respectively. The cutting mechanism 15 comprises an eccentric crank mechanism 151. The eccentric crank mechanism 151 has a moving cutter 152, a driving wheel 153, a moving cutter body 154, a first crank 155 and a guiding device 156.

The center of the driving wheel 153 is connected to the power output shaft of the driving device 12. The moving cutter 152 is set under the moving cutter body 154. An end of the first crank 155 is eccentrically pivoted to a surface of the driving wheel 153, while the other end is pivoted to the moving cutter body 154. The guiding device 156 is adapted to guide the moving cutter body 154 to move in a vertical direction via the driving wheel 153 and the first crank 155 when the power output end of the driving device 12 operates. The fixed cutter 16 is disposed on a lateral side of the forming mechanism 131 and under the guiding device 156. In the cutting mechanism 15, when the end of the first crank 155 connected with the driving wheel 153 moves from the first position 157 to the second position 158, an inner edge of the lower portion of the moving cutter 152 is longitudinally aligned with an outer edge of the fixed cutter 16. The inner edge is provided with a cutting edge 152a which includes an angle of 1° to 3° with the horizontal plane, so that the fixed cutter 16 may interact with the cutting edge 152a of the moving cutter 152 to cut off a portion of the tin strip. By cutting off a portion of the rolled tin strip, at least one tin flake is formed, and then the cutting mechanism 15 moves from the second position 158 back to the first position 157. Briefly speaking, at the pivot end where the first crank 155 of the cutting mechanism 15 is pivoted to the driving wheel 153 of the cutting mechanism 15, there is a linear movement between the first position 157 and the second position 158. In this embodiment, the moving cutter 152 is shaped substantially like a cuboid.

As shown in both FIGS. 1 and 3, the linkage mechanism 14 is linked between the cutting mechanism 15 and the forming mechanism 131, and comprises a second crank 141, a third crank 142 and a ratchet wheel 143. The second crank 141 has one end thereof pivoted to the moving cutter body 154, while the third crank 142 has one end thereof pivoted to the other end of the second crank 141. The center of the ratchet wheel 143 is pivoted to the other end of the third crank 142. The driving gear 132 is coaxially disposed to rotate in the same direction as the ratchet wheel 143. When the ratchet wheel 143 rotates around the center in the first rotating direction 13b, the cutting mechanism 15 is pushed to move towards the second position 158 by the third crank 142 and the second crank 141.

When the cutting mechanism 15 returns from the second position 158 back to the first position 157, the forming mechanism 131 is driven by the linkage mechanism 14 via the upper roller 133 and the lower roller 135 to feed a predetermined length of the tin strip along the first direction. The predetermined length is a fixed length of a tin flake. As shown in FIG. 4C, the tin strip positioning device is disposed between the moving cutter 152 and the fixed cutter 16 to maintain a horizontal position of a portion of the tin strip while the portion of the tin strip passes through the cutting mechanism 15. The tin strip positioning device has a first elastic device 171 disposed on an inside of the moving cutter 152 and a second elastic device 172 disposed on an outside of the fixed cutter 16. The first elastic device 171 provides a downward elastic thrust, while the second elastic device 172 provides an upward elastic thrust. A portion of the tin strip passes between the first elastic device 171 and the second elastic device 172, with a length of this portion forming a tin flake with a fixed length. In this embodiment, both the first elastic device 171 and the second elastic device 172 are springs. However, in other embodiments, the first elastic device 171 and the second elastic device 172 may also be other elastic devices that can provide an elastic thrust.

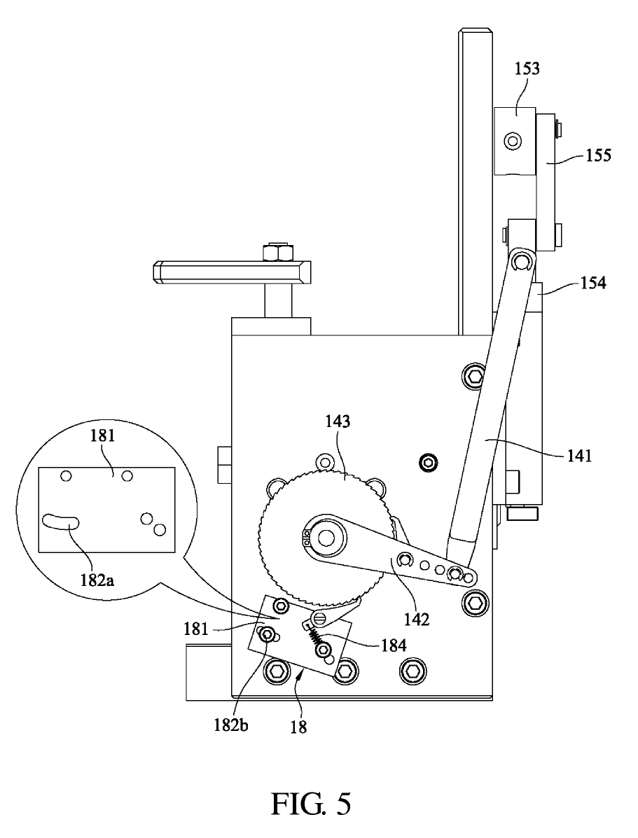

As shown in FIG. 3 and FIG. 5, FIG. 5 illustrates a partial side view of the cutting mechanism, the linkage mechanism and the stop device. The stop device 18 is disposed on a side of a claw 143a of the ratchet wheel 143, and comprises an adjustment block 181, a limiting device, a non-return pawl 183 and an elastic pushing device 184. The adjustment block 181 is pivoted on the other side of the forming mechanism 131. The limiting device comprises an arc hole 182a and a screw 182b threaded through the arc hole 182a. The arc hole 182a is disposed on the adjacent block 181, and the screw 182b is disposed on the other side of the forming mechanism 131. The arc hole 182a of the limiting device limits the range of the adjustment block 181 that pivots relative to the forming mechanism 131. The non-return pawl 183 has an end that pivots the adjustment block 181 and is disposed on the inside of the adjustment block 181. The other end of the non-return pawl 183 has a non-return claw 183a meshing with the claw 143a of the ratchet wheel 143 to allow the ratchet wheel 143 to rotate only in the first rotating direction 13b. The elastic pushing device 184 is disposed on the adjustment block 181 to provide an elastic thrust, so that the non-stop claw 183a of the non-return pawl 183 is meshed with the claw 143a of the ratchet wheel 143. Here, the elastic pushing device 184 is a spring. Consequently, the stop device 18 prevents the ratchet wheel 143 from rotating around the center thereof in a second rotating direction 13c opposite to the first rotating direction 13b.

When a repair soldering operation is to be implemented in an SMT process, the tin flake forming apparatus 1 is used to form a plurality of tin flakes from a continuous wound tin wire that complies with the specifications and sizes of the components involved in the SMT process. A SMT component packaging machine is used to package a plurality of tin flakes into a roll of wound tin flakes. The SMT mounting machine takes a tin flake out of the tin flake roll automatically and mounts it to the location that requires repair soldering. Finally, the tin flake is melted down to complete the soldering. In this way, by eliminating the manual repair soldering procedure, the production efficiency is increased remarkably and an appreciable yield is obtained in terms of the soldering quality.

The tin flake forming apparatus of this invention is only driven by a single motor (the driving device 12), and by using a combination of a crank rocker mechanism and a crank block mechanism, a same eccentric wheel is used as the driving part to generate a regular sequential movement to accomplish the feeding, forming and cutting operations. This provides for a simplified overall structure and highly automated operations. Furthermore, since an adjustable stop device is used in this invention, the ratchet wheels with the same tooth module and the same tooth form but with a different number of teeth may be adopted in the tin flake forming apparatus of this invention by adjusting a location where a screw in the stop device is threaded through the arc hole, thus widening the applicable scope of the tin flake forming apparatus of this invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for forming a continuous tin wire into at least one tin flake, comprising:
a driving device;
a feeding mechanism comprising a conveying mechanism and a forming mechanism, wherein the conveying mechanism transports the continuous tin wire to the forming mechanism along a first direction, and the forming mechanism rolls a portion of the tin wire into a tin strip along the first direction; and
a cutting mechanism, driven by the driving device and moving from a first position to a second position to cut off a portion of the rolled tin strip to form the at least one tin flake, and then moving back from the second position to the first position after cutting off the rolled tin strip;
a linkage mechanism, linked between the cutting mechanism and the forming mechanism, wherein when the cutting mechanism moves back from the second position to the first position, the forming mechanism is driven to feed a predetermined length of the tin strip along the first direction;
a fixed cutter, disposed on a lateral side of the forming mechanism, wherein the cutting mechanism has a moving cutter, and an inner edge of the moving cutter longitudinally aligned with an outer edge of the fixed cutter to cut off a portion of the tin strip when the cutting mechanism is disposed along the second position.

2. The tin flakes forming apparatus as claimed in claim 1, wherein the cutting mechanism further comprises an eccentric crank mechanism, comprising:
a driving wheel, a center thereof connecting to a power output shaft of the driving device;
a moving cutter body, the moving cutter being set under the moving cutter body;
a first crank, an end thereof eccentrically pivoting to a surface of the driving wheel, and the other end thereof eccentrically pivoting to the moving cutter body; and
a guiding device, configured to guide the moving cutter body to enable the cutting mechanism to proceed a linear motion between the first position and the second position when the power output end of the driving device operates.

3. The tin flakes forming apparatus as claimed in claim 2, further comprising a tin strip positioning device disposed between the moving cutter and the fixed cutter for maintaining a horizontal position of a portion of the tin strip while the portion of the tin strip passes through the cutting mechanism.

4. The tin flakes forming apparatus as claimed in claim 3, wherein the tin strip positioning device has a first elastic device disposed on an inside of the moving cutter, and a second elastic device disposed on an outside of the fixed cutter, the first elastic device provides a downward elastic thrust and the second elastic device provides an upward elastic thrust, and the portion of the tin strip passes through between the first elastic device and the second elastic device.

5. The tin flakes forming apparatus as claimed in claim 1, wherein the linkage mechanism has:
a second crank, an end thereof pivoting to the moving cutter body;
a third crank, an end thereof pivoting to the other end of the second crank; and
a ratchet wheel, a center thereof pivoting to the other end of the third crank, and the ratchet wheel being disposed with a driving gear rotating with the ratchet wheel along the same direction;
wherein when the ratchet wheel rotates around the center along a first rotation direction, the cutting mechanism is pushed to move toward the second position by the third crank and the second crank.

6. The tin flakes forming apparatus as claimed in claim 5, wherein the forming mechanism has at least one pair of rolling gears for rolling the portion of the continuous tin wire, transported to the forming mechanism, into the tin strip between the at least one pair of rolling gears, one of the at least one pair of rolling gears meshes with the driving gear, when the ratchet wheel rotates along the first rotation direction, the driving gear drives the meshed rolling gear, and the tin wire between the at least one pair of rolling gears is provided the predetermined length along the first direction.

7. The tin flakes forming apparatus as claimed in claim 6, further comprising a stop device, disposed on a side of a claw of the ratchet wheel, for stopping the ratchet wheel from rotating around the center along a second rotation direction opposite to the first rotation direction.

8. The tin flakes forming apparatus as claimed in claim 7, wherein the stop device has:
an adjustment block, pivoted on the other side of the forming mechanism;
a limiting device for limiting a range of the adjustment block pivoting relative to the forming mechanism;
a non-return pawl, an end thereof pivoting to the adjustment block, a non-return claw, disposed at the other end, engaging with the claw of the ratchet wheel to permit the ratchet wheel rotating only along the first rotation direction; and
an elastic pushing device, disposed on the adjustment block, for providing an elastic thrust to a non-return claw of the non-return pawl engaging with the claw of the ratchet wheel.

9. The tin flakes forming apparatus as claimed in claim 8, wherein the limiting device comprises an arc hole and a screw threading through the arc hole, the arc hole is disposed on the adjustment block, and the screw is disposed on the other side of the forming mechanism.

10. The tin flakes forming apparatus as claimed in claim 1, further comprising a stock device for loading a continuous wound tin wire to be fed to the conveying mechanism.
